(19) United States
(12) Patent Application Publication
(10) Pub. No.: US 2008/0049034 A1
(43) Pub. Date: Feb. 28, 2008

(54) Uniform image display for multiple display devices

(76) Inventors: Daniel Chin, McCook, IL (US); Robert R. Lube, McCook, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/822,734

(22) Filed: Jul. 9, 2007

Related U.S. Application Data
(60) Provisional application No. 60/830,321, filed on Jul. 12, 2006.

(51) Int. Cl. G06F 13/18

(52) U.S. Cl. 345/535

(57) ABSTRACT

Methods and systems for equalizing visual characteristics of images displayed on display units arranged proximate each other. The method may includes generating first and second video signals for first and second display units, respectively, displaying images on the first and second display units based on the first and second video signals, respectively, deriving first and second display correction information for the first and second display units, respectively, deriving image equalization information for the second display unit based on the first and second display correction information, respectively, adjusting the first video signal based on the first display correction information, adjusting the second video signal based on the image equalization information, and displaying images on the first and second images based on the adjusted first and second video signals.

### CROSS REFERENCE TO PRIOR APPLICATION

This application claims priority to and the benefit of U.S. Provisional Patent Application No. 60/830,321 filed on Jul. 12, 2006, which is hereby incorporated by reference in its entirety for all purposes as if fully set forth herein.

### BACKGROUND OF THE INVENTION

1. Field of the Invention

The invention is related to video signal processing, and more particularly to equalizing display characteristics of display devices arranged proximate each other in various light settings.

2. Related Art

Recent advances in flat panel display technology have made flat panel displays such as LCD (liquid crystal display) affordable and hence more desirable for display devices such as gaming consoles (e.g., slot machines, video poker machines and the like). Generally speaking, flat panel displays are lighter, less bulky, consume less power and capable of displaying more vivid and aesthetically-pleasing graphics than CRT displays. FIG. 1 shows a gaming device 10 equipped with a flat panel display 12 such as an LCD panel, mounted within a gaming cabinet 14, which also typically houses other components associated with the LCD panel 12 therein.

One of the problems with prior art display devices is that it is often difficult or impossible to achieve uniform display characteristics (e.g., uniform gamma, brightness, contrast, color, tint, color temperature and/or the like) especially when the video devices are grouped together and arranged proximate each other, especially when the adjustments are attempted through options available through a console's user interface. It becomes even more difficult when the video devices are equipped with flat panel display devices of different makes and models because each may have its own unique inherent gamma. For example, FIG. 2 shows gaming consoles 10A, 10B and 10C grouped together and arranged proximate each other. The consoles 10A, 10B and 10C may be equipped with flat panel display devices 12A, 12B and 12C of different makes and models, respectively, and each console may have preset display characteristics inherently different from each other. Thus, under a uniform ambient light setting, the flat panel display devices 12A, 12B and 12C may appear to non-uniform to the viewer. This may negatively impact the overall aesthetic of the grouped gaming consoles. Especially when the identical images are displayed on the panels 12A, 12B and 12C, the viewers may perceive that the gaming devices 10A, 10B and 10C are not displaying the same images, and thus the overall aesthetic of the console grouping is diminished.

Accordingly, there is a need for a method for uniformly displaying images on multiple display devices.

### SUMMARY OF THE INVENTION

The invention meets the foregoing need and allows displaying images on multiple display devices with uniform visual characteristics, which results in a significant improvement in overall aesthetic of the grouped device devices and other advantages apparent from the discussion herein.

Accordingly, in one aspect of the invention, a display system includes the first display unit configured to display the first image on the first screen thereof based on the first video signal, and the second display unit located proximate the first display unit and configured to display the second image on the second screen thereof based on the second video signal. The second video signal is adjusted based on the display characteristics of the first display unit such that the first and second images displayed on the first and second screens, respectively, have substantially the same visual characteristics.

The first display unit may include the first data source storing the first video data for the first display unit, the first display enhancement unit storing the first display correction information for the first display unit, the first controller configured to generate the first video signal based on the first video data and the first display correction information, and the first display device having the first screen and configured to display the first image on the first screen based on the first video signal from the first controller.

The second display unit may include the second data source storing the second video data for the second display, the second display enhancement unit storing display equalization information for the second display unit; the second controller configured to generate the second video signal based on the second video data and the second display correction information, and the second display device having the second screen and configured to display the second image on the second screen based on the second video signal from the second controller. The second display enhancement unit may further store the second display correction information for the second display unit. The display equalization information may be derived from the first and second display correction information.

The first display correction information may be based on the first video signal and visual characteristics of the first optimized image displayed on the first screen, and the second display correction information is based on the second video signal and visual characteristics of the second optimized image displayed on the second screen. The first and second display correction information and the display equalization information include at least one of gamma, brightness, contrast, tint, color, color temperature and sharpness correction values. The first display correction information and display equalization information may include at least one preset display characteristics optimized for a corresponding ambient light level. The first and second display devices may be a liquid crystal display (LCD) device.

According to anther aspect of the invention, a method of equalizing visual characteristics of images displayed on a plurality of display units arranged proximate each other may include steps of generating the first and second video signals for the first and second display units, respectively, displaying images on the first and second display units based on the first and second video signals, respectively, deriving the first and second display correction information for the first and second display units, respectively, deriving image equalization information for the second display unit based on the first and second display correction information, respectively, adjusting the first video signal based on the first display correction information, adjusting the second video signal based on the image equalization information, and displaying images on the first and second display units based on the adjusted first and second video signals.

The step of deriving first image correction information may include steps of adjusting display characteristics of the first display unit to optimize the image displayed on the first display, detecting visual characteristics of the optimized image displayed on the first display, comparing the detected visual characteristics of the optimized image displayed on the first display unit with the first video signal to derive the first image correction information.

The step of deriving second image correction information may include steps adjusting display characteristics of the second display unit to optimize the image displayed on the second display, detecting visual characteristics of the optimized image displayed on the second display, comparing the detected visual characteristics of the optimized image displayed on the second display unit with the second video signal to derive the first image correction information.

The steps of adjusting the display characteristics of the images displayed on the first and second display units may include a step of adjusting at least one of gamma, brightness, contrast, tint, color, color temperature and sharpness values for the first and second display units. The display characteristics may comprise at least one of gamma, brightness, contrast, tint, color, color temperature and sharpness correction values. The first and second display correction information may include at least one of gamma, brightness, contrast, tint, color, color temperature and sharpness correction values for the first and second display units. The image equalization information may include at least one of gamma, brightness, contrast, tint, color, color temperature and sharpness correction values for the second display unit.

According to yet anther aspect of the invention, a method of equalizing visual characteristic of images displayed on display units arranged proximate each other includes generating the first and second video signals for the first and second display units, respectively, determining the first display correction information for the first display, the first display correction information being optimized for the first ambient light level, determining the second display correction information for the second display unit, determining image equalization information for the second display unit based on the first and second display correction information, adjusting the first video signal based on the first display correction information, adjusting the second video signal based on the image equalization information, and displaying the first and second images on the first and second display units, respectively, based on the adjusted first and second video signals.

The method may further include a step of storing the first display correction information and the image equalization information as the first preset for the first ambient light level. The method may further include steps of installing the first and second display units in the first environment having the first ambient light level, and selecting the first preset for the first and second display units to display images optimized for the first ambient light level. The method may further include steps of determining a plurality of presets for a plurality of ambient light levels, installing the first and second display units in the second environment having the second ambient light level, and selecting one of the plurality of presets corresponding to the second ambient light level to display an image optimized for the second ambient light level.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a conventional gaming device equipped with an LCD panel;

FIG. 2 shows a group of gaming devices shown in FIG. 1 arranged proximate each other;

FIG. 3 shows an overall structure for a display equalization scheme for multiple display devices, constructed according to the principles of the invention;

FIG. 4 shows process steps for the display equalization scheme for multiple display devices according to the principles of the invention; and

FIG. 6 shows process steps for equalizing visual characteristics of images displayed on the grouped video devices of FIG. 4 depending on an ambient light level, constructed according to the principles of the invention.

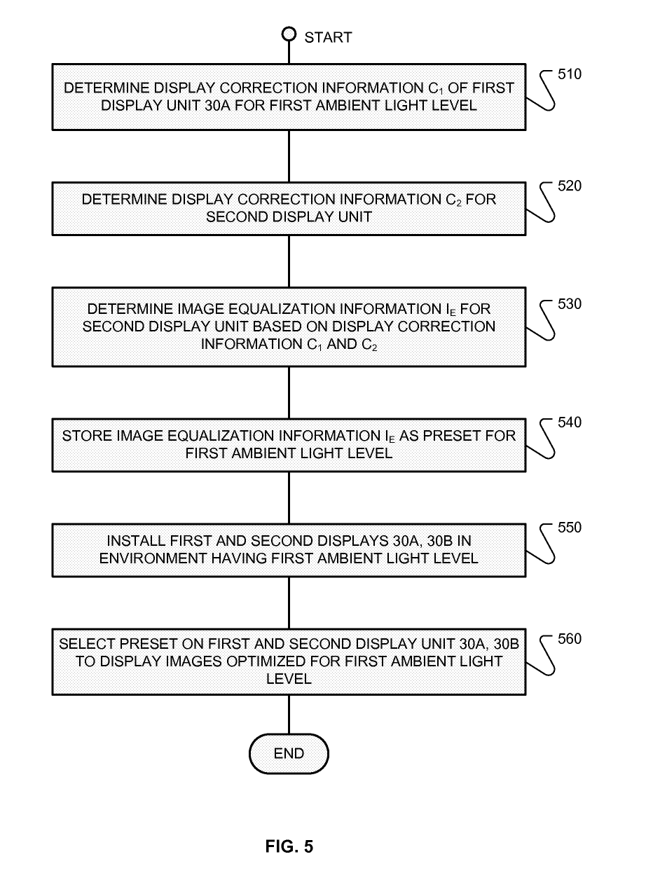

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

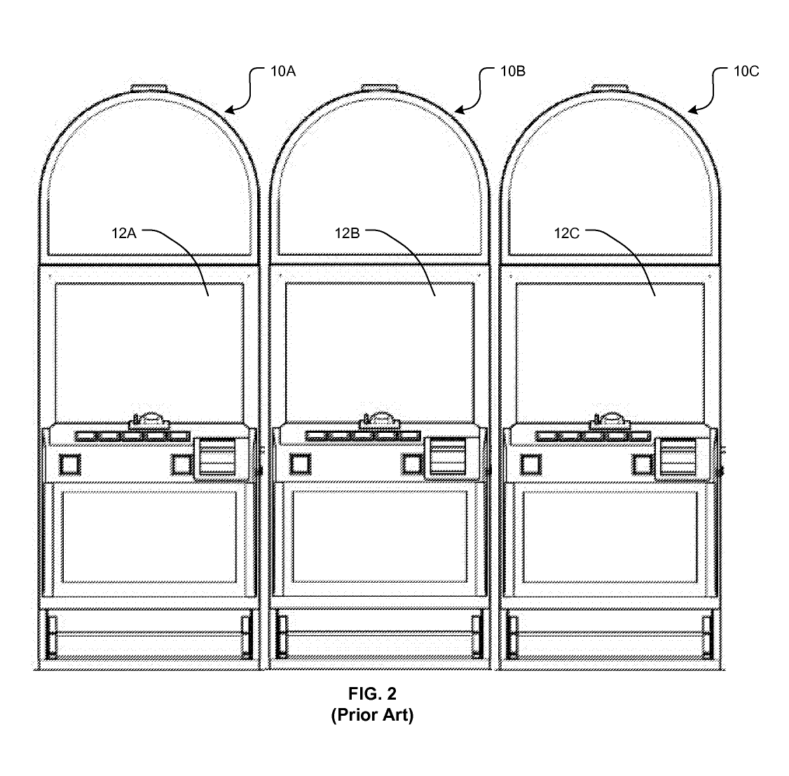

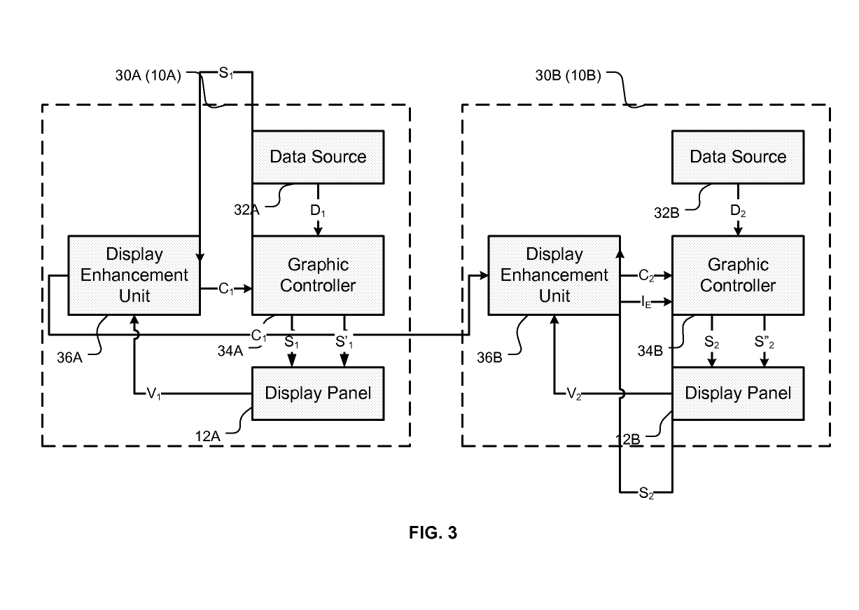

FIG. 3 conceptually shows an overall structure of a display equalization scheme for multiple display devices, constructed according to the principles of the invention. The structure may include at least two display units 30A and 30B, that may be implemented in at least two display devices, respectively, for example, the gaming consoles 10A, 10B shown in FIG. 2. The display unit 30A may include a data source 32A, graphic controller 34A, display enhancement unit 36A, and display panel 12A. Similarly, the display unit 30B may include a data source 32B, graphic controller 34B, display enhancement unit 36B, and display panel 12B.

The data sources 32A, 32B may provide video data D₁, D₂ to the consoles 10A, 10B, respectively. The video data D₁, D₂ may be the identical video data for displaying the identical images on the display panels 12A, 12B. For example, the data sources 32A, 32B may be a single data source such as a data storage at a centralized location, which may provide the identical video data D₁, D₂ to display the identical images on the display panels 12A, 12B simultaneously or randomly. Alternatively, the data sources 32A, 32B may provide different video data D₁, D₂ to the corresponding consoles 10A, 10B, respectively. For example, the data sources 32A, 32B may be internal data storages for the consoles 10A, 10B, respectively. However, when the consoles 10A, 10B run the same gaming program (e.g., video poker program), the video data D₁, D₂ from the two different data sources 32A, 32B may result in similar images (e.g., identical screen layout, color-scheme and/or the like) being displayed on the display panels 12A, 12B.

After receiving the video data D₁ from the data source 32A, the graphic controller 34A may generate a video signal S₁ based on the video data D₁, and send the video signal S₁ to the display panel 12A, which displays an image representing the video signal S₁ on the screen thereof. In order to optimize the image displayed on the display panel 12A, the graphic controller 34A may access the display enhancement unit 36A to obtain display correction information C₁, adjust video signal S₁ based on the display correction information C₁ and provide an adjusted video signal S′₁ to the display panel 12A. The display correction information C₁ may include one or more presets of display correction values (e.g., gamma, brightness, contrast, color, tint, color temperature and/or the like), which may be selected in conjunction with corresponding luminance settings suitable for different lighting levels such as, for example, dark, average and bright lighting levels. The display correction information C₁ may be determined by comparing the display correction information C₁ and visual characteristics V₁ of the image displayed on the display panel 12A, which will be discussed below in detail. The display enhancement unit 36A may include a data storage such as EPROM or the like to store the display correction information C₁.

The display unit 30B may be configured and operate in a substantially similar manner to the display unit 30A. However, since the inherent display characteristics and/or preset display characteristic values of the display panel 12B may be different from those of the display panel 12A, a video signal S₂ from the graphic controller 34B may require adjustment, different from the adjustment made to video data D₁, in order to display an image having substantially the same visual characteristics with the image displayed on the panel 12A. Such adjustment may be even more critical when the video data D₁ and D₂ are intended for displaying the identical or similar images.

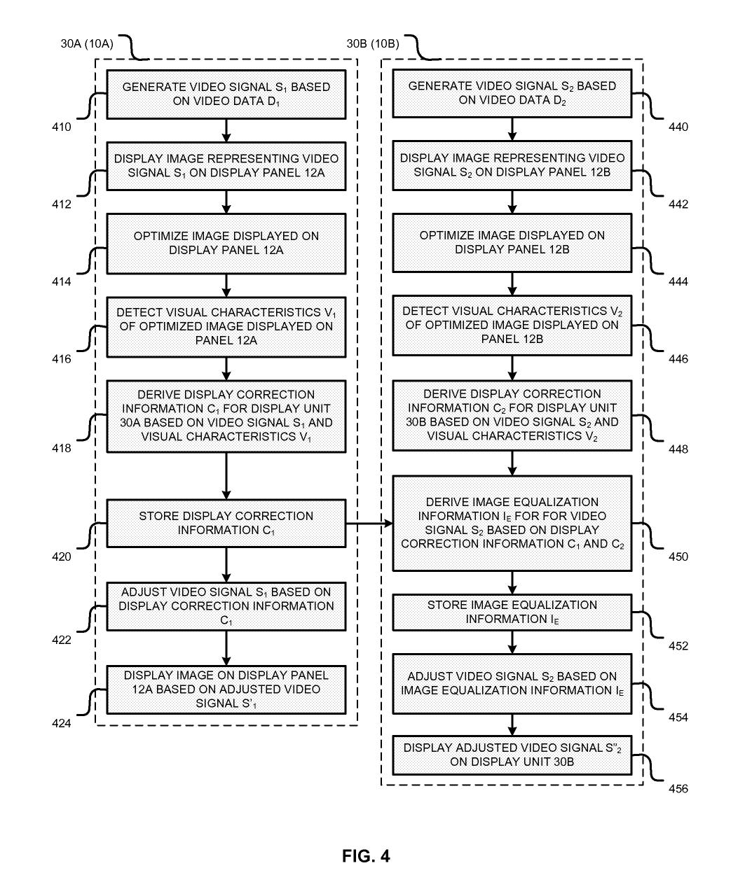

FIG. 4 shows a flow chart describing the processing steps for equalizing visual characteristics of multiple display devices, such as the display devices 10A, 10B shown in FIG. 3, constructed according to the principles of the invention. At step 410, the graphic controller 34A of the display unit 30A may generate the video signal S₁ based on the video data D₁ received from the data source 32A. Similarly, at step 440, the graphic controller 34B of the display unit 30B may generate the video signal S₂ based on the video data D₂ received from the data source 32B. At the steps 412, 442, the display panels 12A, 12B may display images representing the video signals S₁, S₂, respectively, on their respective screens. At steps 414, 444, the user may adjust display settings (e.g. gamma, brightness, color, contrast, color temperature, refresh rate and/or the like) to optimize the images displayed on the display panel 12A, 12B. The display settings may be adjusted using an on-screen display (OSD) menu feature implemented to the display panels 12A, 12B. Additionally or alternatively, the display settings may be adjusted using control buttons provided to the display units 30A, 30B. While optimizing the images displayed on the display panels 12A, 12B, the user may also equalize the display characteristics of the images displayed on the display units 30A, 30B.

At steps 416, 446, the visual characteristics V₁, V₂ (e.g., gamma, brightness, contrast, color, tint, color temperature and/or the like) of the optimized images displayed on the display panel 12A, 12B, respectively, may be detected using, for example, a software program, such as COLORFACTS™ from Milori, Inc. of Lawrenceville, N.J. or an apparatus performing the same functions. At step 418, display correction information C₁ for the display unit 30A may be derived based on the visual characteristics V₁ and the video signal S₁. For example, the display correction information C₁ may be derived by comparing the visual characteristics V₁ of the optimized image displayed on the display panel 12A with the video signal S₁ to determine the differences in the visual characteristics between the optimized image displayed on the display panel 12A and the unaltered video signal S₁ from the graphic controller 34A. Similarly, at step 448, display correction information C₂ for the display unit 30B may be derived based on the visual characteristics V₂ and the video signal S₂. At step 422, once the display correction information C₁ is stored, the graphic controller 34A may access the display enhancement unit 36A at anytime to adjust the video signal S₁ based on the display correction information C₁ and generate an adjusted video signal S′₁. At step 424, the adjusted video signal S′₁ may be provided to the display panel 12A, which may display an image representing the adjusted video signal S′₁ on the screen thereof.

In order to equalize the visual characteristics of the images displayed on the display panels 12A, 12B, the display correction information C₁ may be provided to the display unit 30B and compared to the display correction information C₂ of the display unit 30B to derive image equalization information I_{E} for the display unit 30B. For example, the image equalization information I_{E} may include display characteristics correction values such as gamma, brightness, contrast, tint, color, color temperature correction values or the like that may be used to adjust the video signal V₂ such that the image displayed on the display panel 12B may have substantially the same visual characteristics as the those of the image displayed on the display on the display panel 12A. At step 452, the image equalization information I_{E} may be stored in a data storage, such as an internal data storage of the display enhancement unit 36B. At step 454, the controller 34B may adjust the video signal S₂ based on the image equalization information I_{E} and generate an adjusted video signal S″₂. At step 456, the display panel 12B may display an image representing the adjusted video signal S″₂ on the screen thereof. Thus, according to the invention, the visual characteristics of the images displayed on two proximate display units are equalized regardless of the inherent differences in display characteristics between the grouped display devices.

The ambient light level of the environment where the display devices 10A, 10B are installed may vary. Thus, the display units 30A, 30B may be provided with one or more presets of predetermined video signal correction values, which may be selected to optimize the display characteristics for various ambient lighting levels such as, for example, dark, average and bright ambient lighting levels. In configuring the display units 30A,30B for a specific ambient luminance setting, it may be necessary to adjust the display characteristics of both of the display units 30A,30B such that the display units 30A,30B may display images of the same display characteristics that are also optimized for a specified ambient lighting level. FIG. 5 shows a flow chart describing the processing steps of equalizing the display characteristics of multiple LCD devices for one or more ambient lighting levels, constructed according to the principles of the invention.

At step 510, to optimize the image displayed on the first display unit 30A in the first ambient light level, the display correction information C₁ may be determined specifically for the first ambient light level. The display correction information C₁ may be determined by performing the steps 410, 412, 414, 416, 418 of FIG. 4 in the first ambient light level. Similarly, at step 520, the display correction information C₂ may be determined specifically for the second display unit 30B in the first ambient light level. At step 530, image equalization information I_{E} for the second display unit 30B for the first ambient light level may be determined based on the display correction information C₁ and C₂. At step 540, the display correction information C₁ and the image equalization information I_{E} may be stored in the image enhancement units 36A, 36B, respectively as a preset for the first ambient light level. The steps 510, 520, 530 may be repeated to create more presets for different ambient light levels. At step 550, the display unit 30A, 30B may be installed in an environment having the first ambient light level. At step 560, the preset may be selected to display images having substantially the same display characteristics that are also optimized for the first ambient light level. Thus, according to the invention, it is possible to display images of substantially the same display characteristics that are optimized for a specific ambient light level on multiple display devices.

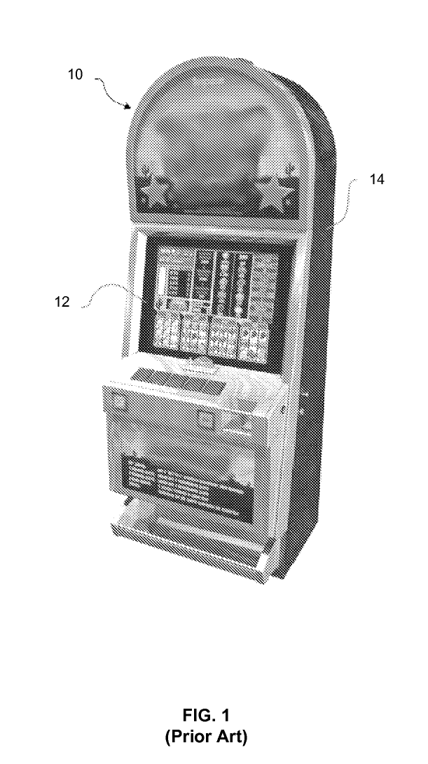

In an embodiment, more than one preset may be created and selected for various ambient light conditions (e.g., LOW, MED LOW, STANDARD, MED HIGH and HIGH). The presets may be selected by way of a touch screen menu or the like. The presets may be alternately selected by way of, for example, buttons, a control pad or the like. The buttons may be mounted within the cabinet 14 shown in FIG. 1 for limited access only by an authorized operator. The buttons may allow the operator to select and adjust various display functions by way of an on-screen menu that appears during the adjustment process. For example, the buttons may include a “mode” button that calls up a number of mode descriptors on the LCD display, one or more of which may correspond to the appropriate preset to the lighting condition in which the console is installed. While the present invention, in one embodiment, is particularly well suited for use with LCD devices as will be explained herein, the devices and methods described may be used with other video displays, such as plasma, FED, and OLED displays with similar benefits.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A display system comprising:
a first display unit configured to display a first image on a first screen thereof based on a first video signal; and
a second display unit located proximate the first display unit and configured to display a second image on a second screen thereof based on a second video signal,
wherein the second video signal is adjusted based on the display characteristics of the first display unit such that the first and second images displayed on the first and second screens, respectively, have substantially the same visual characteristics.

2. The display system of claim 1, wherein the first display unit comprises:
a first data source storing first video data for the first display unit;
a first display enhancement unit storing first display correction information for the first display unit;
a first controller configured to generate the first video signal based on the first video data and the first display correction information; and
a first display device having the first screen and configured to display the first image on the first screen based on the first video signal from the first controller.

3. The display system of claim 2, wherein the second display unit comprises:
a second data source storing second video data for the second display;
a second display enhancement unit storing display equalization information for the second display unit;
a second controller configured to generate the second video signal based on the second video data and the second display correction information; and
a second display device having the second screen and configured to display the second image on the second screen based on the second video signal from the second controller.

4. The display system of claim 3, wherein the second display enhancement unit further stores second display correction information for the second display unit.

5. The display system of claim 4, wherein the display equalization information is derived from the first and second display correction information.

6. The display system of claim 5, wherein the first display correction information is based on the first video signal and visual characteristics of a first optimized image displayed on the first screen, and the second display correction information is based on the second video signal and visual characteristics of a second optimized image displayed on the second screen.

7. The display system of claim 6, wherein the first and second display correction information and the display equalization information include at least one of gamma, brightness, contrast, tint, color, color temperature and sharpness correction values.

8. The display system of claim 5, wherein the first display correction information and display equalization information include at least one preset display characteristics optimized for a corresponding ambient light level.

9. The display system of claim 3, wherein the first and second display devices are a liquid crystal display (LCD) device.

10. A method of equalizing visual characteristics of images displayed on a plurality of display units arranged proximate each other, the method comprising steps of:
generating first and second video signals for first and second display units, respectively;
displaying images on the first and second display units based on the first and second video signals, respectively;
deriving first and second display correction information for the first and second display units, respectively;
deriving image equalization information for the second display unit based on the first and second display correction information, respectively;
adjusting the first video signal based on the first display correction information;
adjusting the second video signal based on the image equalization information; and
displaying images on the first and second display units based on the adjusted first and second video signals.

11. The method of claim 10, wherein the step of deriving first image correction information comprises steps of:
adjusting display characteristics of the first display unit to optimize the image displayed on the first display;
detecting visual characteristics of the optimized image displayed on the first display;
comparing the detected visual characteristics of the optimized image displayed on the first display unit with the first video signal to derive the first image correction information.

12. The method of claim 11, wherein the step of deriving second image correction information comprises steps of:
adjusting display characteristics of the second display unit to optimize the image displayed on the second display;
detecting visual characteristics of the optimized image displayed on the second display;
comparing the detected visual characteristics of the optimized image displayed on the second display unit with the second video signal to derive the first image correction information.

13. The method of claim 12, wherein the steps of adjusting the display characteristics of the images displayed on the first and second display units comprises a step of adjusting at least one of gamma, brightness, contrast, tint, color, color temperature and sharpness values for the first and second display units.

14. The method of claim 13, wherein the display characteristics comprise at least one of gamma, brightness, contrast, tint, color, color temperature and sharpness correction values.

15. The method of claim 10, wherein the first and second display correction information comprises at least one of gamma, brightness, contrast, tint, color, color temperature and sharpness correction values for the first and second display units.

16. The method of claim 10, wherein the image equalization information comprises at least one of gamma, brightness, contrast, tint, color, color temperature and sharpness correction values for the second display unit.

17. A method of equalizing visual characteristic of images displayed on display units arranged proximate each other, the method comprising steps of:
generating first and second video signals for first and second display units, respectively;
determining first display correction information for the first display, the first display correction information being optimized for a first ambient light level;
determining second display correction information for a second display unit;
determining image equalization information for the second display unit based on the first and second display correction information;
adjusting the first video signal based on the first display correction information;
adjusting the second video signal based on the image equalization information; and
displaying first and second images on the first and second display units, respectively, based on the adjusted first and second video signals.

18. The method of claim 17, further comprising a step of storing the first display correction information and the image equalization information as a first preset for the first ambient light level.

19. The method of claim 18, further comprises steps of:
installing the first and second display units in a first environment having the first ambient light level; and
selecting the first preset for the first and second display units to display images optimized for the first ambient light level.

20. The method of claim 18, further comprises steps of:
determining a plurality of presets for a plurality of ambient light levels;
installing the first and second display units in a second environment having a second ambient light level; and
selecting one of the plurality of presets corresponding to the second ambient light level to display an image optimized for the second ambient light level.
